(19) United States
(12) Patent Application Publication
(10) Pub. No.: US 2021/0252511 A1
(43) Pub. Date: Aug. 19, 2021

(54) FLUID-HANDLING DEVICE AND FLUID-HANDLING SYSTEM

(71) Applicant: Enplas Corporation, Saitama (JP)

(72) Inventor: Nobuya SUNAGA, Saitama (JP)

(73) Assignee: Enplas Corporation, Saitama (JP)

(21) Appl. No.: 17/259,217

(22) PCT Filed: Jun. 17, 2019
(86) PCT No.: PCT/JP2019/023852

§ 371 Date: Jan. 11, 2021

(30) Foreign Application Priority Data
Jul. 12, 2018 (JP) 2018-132249

(51) Int. Cl. B01L 3/00; F16K 11/22

(52) U.S. Cl. CPC B01L 3/502746; B01L 3/567; B01L 2300/0816; B01L 2400/082; F16K 11/22

(57) ABSTRACT

This fluid-handling device has: a first rotary member having a first protrusion that expands a diaphragm of a valve and closes off the valve, the first rotary member being capable of rotating about a rotational axis; a second rotary member disposed so as to surround the first rotary member, the second rotary member having a second protrusion that expands the diaphragm of the valve and closes off the valve, and being capable of rotating about the rotational axis independently from the first rotary member; and a plurality of rolling elements disposed between the first rotary member and the second rotary member, the plurality of rolling elements being in contact with the first rotary member and the second rotary member.

### TECHNICAL FIELD

The present invention relates to a fluid handling device and a fluid handling system.

### BACKGROUND ART

In recent years, a channel chip is used to analyze trace amounts of substances such as proteins and nucleic acids with high precision and speed. Advantageously, a channel chip requires only a small amount of sample or reagent required for an analysis, and is expected to be used for various uses such as laboratory tests, food tests, and environment tests. For example, PTL 1 discloses a micro valve unit that includes a channel chip including a plurality of micro valves, and a pressing part for controlling the opening and closing of the micro valves. In the channel chip, the micro valves are disposed on the same circumference. In addition, the pressing part includes a contact surface having an arc-like shape in plan view. When the pressing part is rotated, the contact surface of the pressing part moves. In this manner, the diaphragm of the micro valve is pressed, or not pressed by the pressing part. The micro valve is closed when pressed by the pressing part, and the micro valve is open when not pressed by the pressing part.

### CITATION LIST

### Patent Literature

### PTL 1

### Japanese Patent Application Laid-Open No. 2007-085537

### SUMMARY OF INVENTION

### Technical Problem

As described above, in the device (micro valve unit) disclosed in PTL 1, a rotary member (pressing part) including a protrusion (end surface) having an arc-like shape in plan view is rotated to control the opening and closing of the valves (micro valves). When the channel chip includes a plurality of valves in such a device, the valves may not be opened and closed in the intended order. This problem is described below with reference to FIGS. 1A to 2B.

FIG. 1A is a plan view of a channel chip for describing a problem of a known technique. FIG. 1B is a bottom view of a rotary member combined with the channel chip illustrated in FIG. 1A. As illustrated in FIG. 1A, the channel chip includes first inlet 10, first introduction channel 11, first valve 12, second inlet 20, second introduction channel 21, second valve 22, third inlet 30, third introduction channel 31, third valve 32, common channel 40 and outlet 41. The upstream end of first introduction channel 11 is connected to first inlet 10, and the downstream end of first introduction channel 11 is connected to the upstream end of common channel 40. The upstream end of second introduction channel 21 is connected to second inlet 20, and the downstream end of second introduction channel 21 is connected to the upstream end of common channel 40. The upstream end of third introduction channel 31 is connected to third inlet 30, and the downstream end of third introduction channel 31 is connected to the upstream end of common channel 40. First introduction channel 11, second introduction channel 21 and third introduction channel 31 are provided with first valve 12, second valve 22 and third valve 32, respectively. The downstream end of common channel 40 is connected to outlet 41.

In addition, as illustrated in FIG. 1B, the rotary member includes protrusion 50 having an arc-like shape in plan view for pressing first valve 12, second valve 22 and third valve 32, and recess 51 disposed on the same circumference as protrusion 50. In FIG. 1B, the bottom surface (the surface that makes contact with the channel chip) of protrusion 50 is hatched. First valve 12, second valve 22 and third valve 32 are closed when pressed by protrusion 50, but are open when not pressed by protrusion 50.

For example, as illustrated in FIG. 2A, the rotary member is rotated such that recess 51 is located on first valve 12 and that protrusion 50 is located on second valve 22 and third valve 32. In this case, first valve 12 is open, and the fluid in first inlet 10 can flow to outlet 41 through first introduction channel 11 and common channel 40. On the other hand, second valve 22 and third valve 32 are closed, and therefore the liquid in second inlet 20 and the fluid in third inlet 30 cannot flow toward outlet 41.

Thereafter, when it is desired to cause the fluid in third inlet 30 to flow toward outlet 41, the rotary member is rotated such that recess 51 is located on third valve 32 and that protrusion 50 is located on first valve 12 and second valve 22. However, as illustrated in FIG. 2B, while the rotary member is rotated, recess 51 is temporarily located on second valve 22 and protrusion 50 is temporarily located on first valve 12 and third valve 32. As a result, the fluid in second inlet 20 that is not intended to deliver may flow toward outlet 41.

As described above, in the case where the channel chip includes multiple valves in a known device, it is difficult to control the opening and closing of a valve in an intended order if only one rotary member is used. Therefore, there is a demand for a fluid handling device including a plurality of rotary members each of which includes a protrusion of an arc-like shape in plan view.

The present inventor studied a fluid handling device including a plurality of rotary members, and found that a press against a valve at a desired position becomes difficult due to poor rotatability due to a plurality of rotary members concentrically disposed around the rotation axis, which causes friction between the inner rotary member (first rotary member) and the outer rotary member (second rotary member) when they are rotated.

In view of this, the present inventor attached a commercially available ball bearing to a recess formed in one rotary member in order to reduce the friction between two rotary members, and it was confirmed that the friction between the rotary members was reduced, but the distance between the rotary members was varied. For example, when it is desired to bring both the first protrusion of the first rotary member on the inner side and the second protrusion of the second rotary member on the outer side into contact with one valve, it is preferable that the distance between the first protrusion and the second protrusion be narrow. However, if the ball bearing is attached and the distance between the two rotary members is varied as described above, it is difficult to appropriately bring both the first protrusion and the second protrusion into contact with one valve, and the opening and closing of the valve may not be appropriately controlled.

Under such circumstances, an object of the present invention is to achieve a fluid handling device and a fluid handling system that can accurately control the opening and closing of a valve even with a plurality of rotary members.

### Solution to Problem

A fluid handling device according to an embodiment of the present invention is configured to control fluid in a channel chip including a first channel, a second channel, and a valve disposed between the first channel and the second channel, the fluid handling device including a first rotary member including a first protrusion and configured to be rotatable around a rotation axis, the first protrusion being configured to press a diaphragm of the valve to close the valve; a second rotary member disposed to surround the first rotary member and including a second protrusion configured to press the diaphragm of the valve to close the valve, the second rotary member being rotatable around the rotation axis separately from the first rotary member; and a plurality of rolling members disposed between the first rotary member and the second rotary member, the plurality of rolling members being in contact with the first rotary member and the second rotary member.

A fluid handling system according to an embodiment of the present invention includes a channel chip including a first channel, a second channel, and a valve disposed between the first channel and the second channel; and the above-mentioned fluid handling device.

### Advantageous Effects of Invention

According to the present invention, it is possible to achieve a fluid handling device and a fluid handling system that can accurately control the opening and closing of a valve even with a plurality of rotary members.

### BRIEF DESCRIPTION OF DRAWINGS

FIG. 1A is a plan view of a channel chip for describing a problem of a known technique, and FIG. 1B is a bottom view of a rotary member combined with the channel chip illustrated in FIG. 1A;

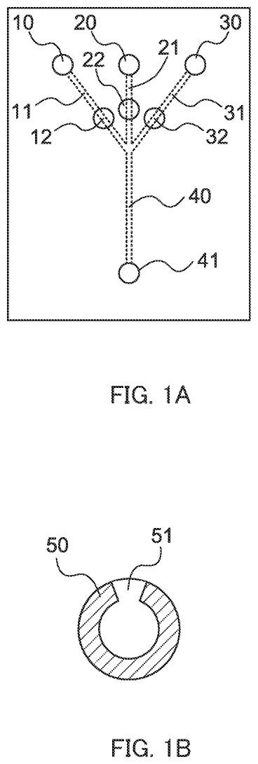

FIGS. 2A and 2B are schematic views illustrating an example use of the channel chip illustrated in FIG. 1A and the rotary member illustrated in FIG. 1B;

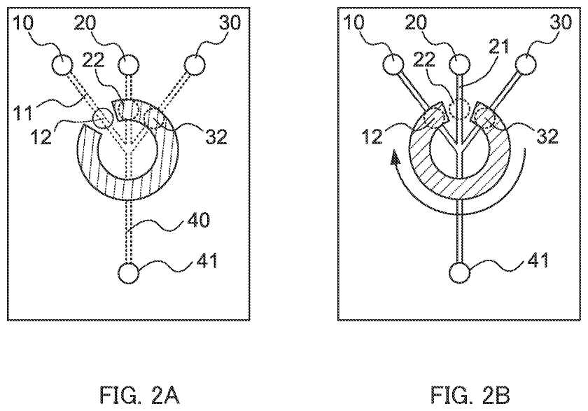

FIG. 3 is a sectional view illustrating a configuration of a fluid handling device and a channel chip according to an embodiment;

FIG. 4 is a plan view illustrating a configuration of the channel chip according to the embodiment;

FIG. 5 is a plan view of a rotary member according to the embodiment;

FIG. 6 is a schematic view for describing an operation of the fluid handling device according to the embodiment;

FIG. 7 is a schematic view for describing an operation of the fluid handling device according to the embodiment;

FIG. 8 is a schematic view for describing an operation of the fluid handling device according to the embodiment; and

FIGS. 9A and 9B are sectional views illustrating another configuration of the fluid handling device according to the embodiment.

### DESCRIPTION OF EMBODIMENTS

An embodiment of the present invention is elaborated below with reference to the accompanying drawings.

### EMBODIMENT

### Configurations of Fluid Handling Device and Channel Chip

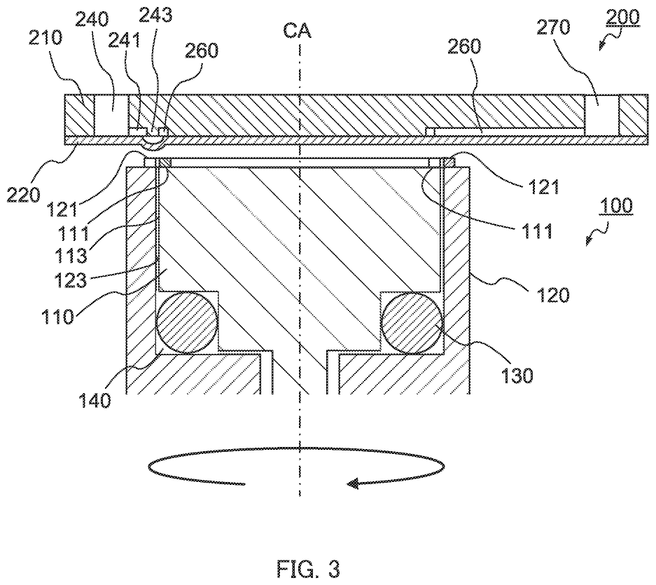

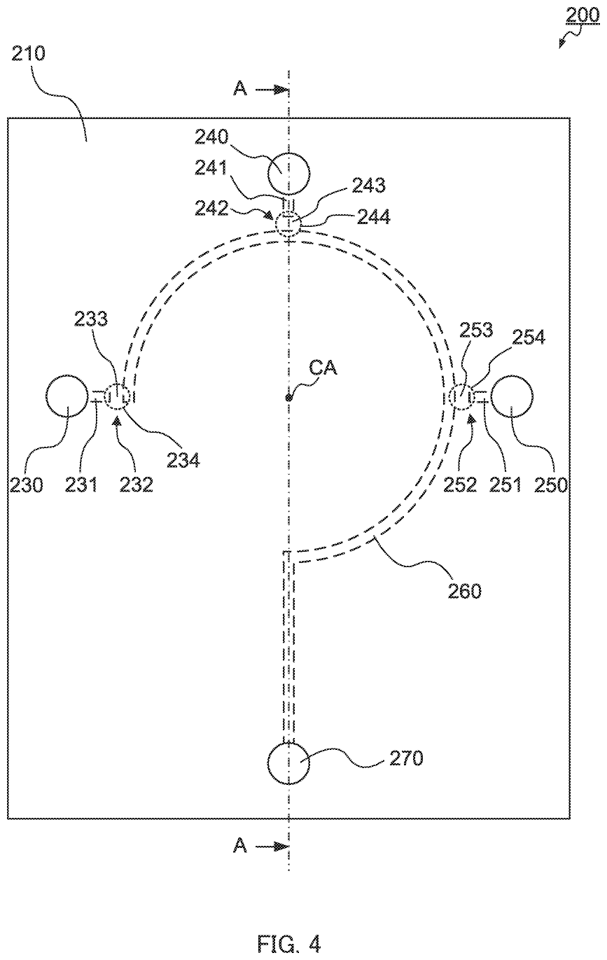

FIG. 3 is a sectional view illustrating a configuration of a fluid handling system (fluid handling device 100 and channel chip 200) according to an embodiment (a sectional view taken along line A-A of FIG. 4). As illustrated in FIG. 3, fluid handling device 100 includes first rotary member 110 and second rotary member 120 disposed to surround first rotary member 110. First rotary member 110 and second rotary member 120 are rotated about central axis CA by an external driving mechanism (not illustrated). In first rotary member 110 and second rotary member 120, recess 140 for housing a plurality of rolling members 130 is formed, and the plurality of rolling members 130 is disposed to be in contact with first rotary member 110 and second rotary member 120. Channel chip 200 includes substrate 210 and film 220, and is disposed to fluid handling device 100 in such a manner that film 220 makes contact with first rotary member 110 and second rotary member 120. Note that in FIG. 3, fluid handling device 100 and channel chip 200 are separated away from each other for the sake of clarity of illustration of their configurations.

FIG. 4 is a plan view illustrating a configuration of channel chip 200 according to the embodiment. Channel chip 200 includes substrate 210 and film 220, and is disposed to fluid handling device 100 in such a manner that film 220 makes contact with first protrusion 111 of first rotary member 110 and second protrusion 121 of second rotary member 120. In FIG. 4, a groove (channel) formed in the surface of substrate 210 on film 220 side and a diaphragm formed in film 220 are illustrated with broken lines.

As described above, channel chip 200 includes substrate 210 and film 220 (see FIG. 4). A groove configured to be a channel and a through hole configured to be an inlet or an outlet are formed in substrate 210. Film 220 is joined to one surface of substrate 210 so as to close the openings of the recess and the through hole formed in substrate 210. A partial region of film 220 functions as a diaphragm. The groove of substrate 210 closed with film 220 serves as a channel for carrying fluid such as reagent, liquid sample, gas, and powder.

The thickness of substrate 210 is not limited. For example, the thickness of substrate 210 is 1 mm to 10 mm. In addition, the material of substrate 210 is not limited. For example, the material of substrate 210 may be appropriately selected from publicly known resins and glass. Examples of the material of substrate 210 include polyethylene terephthalate, polycarbonate, polymethylmethacrylate, polyvinyl chloride, polypropylene, polyether, polyethylene, polystyrene, silicone resin and elastomer.

The thickness of film 220 is not limited as long as it can serve as a diaphragm. For example, the thickness of film 220 is 30 μm to 300 μm. In addition, the material of film 220 is not limited as long as it can function as a diaphragm. For example, the material of film 220 may be appropriately selected from publicly known resins. Examples of the material of film 220 include polyethylene terephthalate, polycarbonate, polymethylmethacrylate, polyvinyl chloride, polypropylene, polyether, polyethylene, polystyrene, silicone resin and elastomer. Film 220 is joined to substrate 210 by thermal welding, laser welding, adhesive agents and the like, for example.

As illustrated in FIG. 4, channel chip 200 according to the present embodiment includes first inlet 230, first introduction channel 231, first valve 232, second inlet 240, second introduction channel 241, second valve 242, third inlet 250, third introduction channel 251, third valve 252, common channel 260 and outlet 270. First introduction channel 231, second introduction channel 241 and third introduction channel 251 correspond to the first channel in claims, and common channel 260 corresponds to the second channel in claims.

First inlet 230, second inlet 240 and third inlet 250 are bottomed recesses for introducing fluid. In the present embodiment, each of first inlet 230, second inlet 240 and third inlet 250 is composed of a through hole formed in substrate 210, and film 220 closing one opening of the through hole. The shape and the size of each inlet are not limited and may be appropriately set as necessary. Each inlet has a substantially columnar shape, for example. Each inlet has a width of about 2 mm, for example. The type of the fluid housed in each inlet may be appropriately selected in accordance with the use of channel chip 200. The fluid is fluid such as reagent, liquid sample and powder.

First introduction channel 231, second introduction channel 241 and third introduction channel 251 are channels in which fluid can move. The upstream ends of first introduction channel 231, second introduction channel 241 and third introduction channel 251 are connected to first inlet 230, second inlet 240 and third inlet 250, respectively. The downstream ends of first introduction channel 231, second introduction channel 241 and third introduction channel 251 are connected to common channel 260 at respective positions different from each other. In the present embodiment, each of first introduction channel 231, second introduction channel 241 and third introduction channel 251 is composed of a groove formed in substrate 210, and film 220 closing the opening of the groove. The cross-sectional area and the cross-sectional shape of each channel are not limited. In this specification, “cross-section of channel” means a cross-section of the channel orthogonal to the direction in which the fluid flows. The cross-sectional shape of each channel is a substantially rectangular shape with each side (width and depth) having a length of about several tens of micrometers, for example. The cross-sectional area of each channel may be or may not be constant in the flow direction of the fluid. In the present embodiment, the cross-sectional area of each channel is constant.

First valve 232, second valve 242 and third valve 252 are diaphragm valves that control the flow of the fluid in first introduction channel 231, second introduction channel 241 and third introduction channel 251, respectively. First valve 232 is disposed in first introduction channel 231 or at the connecting portion between first introduction channel 231 and common channel 260. Second valve 242 is disposed in second introduction channel 241 or at the connecting portion between second introduction channel 241 and common channel 260. Third valve 252 is disposed in third introduction channel 251 or at the connecting portion between third introduction channel 251 and common channel 260. In the present embodiment, first valve 232 is disposed at the connecting portion between first introduction channel 231 and common channel 260, second valve 242 is disposed at the connecting portion between second introduction channel 241 and common channel 260, and third valve 252 is disposed at the connecting portion between third introduction channel 251 and common channel 260. In addition, first valve 232, second valve 242 and third valve 252 are disposed on a circumference of a circle around central axis CA.

First valve 232 includes first partition wall 233 and first diaphragm 234. Likewise, second valve 242 includes second partition wall 243 and second diaphragm 244, and third valve 252 includes third partition wall 253 and third diaphragm 254. In the present embodiment, first partition wall 233 is disposed between first introduction channel 231 and common channel 260. Likewise, second valve 242 is disposed between second introduction channel 241 and common channel 260, and third valve 252 is disposed between third introduction channel 251 and common channel 260. In addition, first diaphragm 234 is disposed opposite to first partition wall 233. Likewise, second diaphragm 244 is disposed opposite to second partition wall 243, and third diaphragm 254 is disposed opposite to third partition wall 253.

First partition wall 233 functions as a valve seat of a diaphragm valve for opening and closing between first introduction channel 231 and common channel 260. Likewise, second partition wall 243 functions as a valve seat of a diaphragm valve for opening and closing between second introduction channel 241 and common channel 260, and third partition wall 253 functions as a valve seat of a diaphragm valve for opening and closing between third introduction channel 251 and common channel 260. The shape and the height of each partition wall are not limited as long as the above-mentioned function can be ensured. The shape of each partition wall is a rectangular prism shape, for example. The height of each partition wall is equal to the depth of the introduction channel and common channel 260, for example.

Each of first diaphragm 234, second diaphragm 244 and third diaphragm 254 is a portion of film 220 having flexibility and has a substantially spherical cap shape (see FIG. 3). Film 220 is disposed on substrate 210 such that each diaphragm is opposite to the corresponding partition wall without making contact with the partition wall. Each diaphragm deflects toward the corresponding partition wall when pressed by first protrusion 111 (described later) of first rotary member 110 or second protrusion 121 (described later) of second rotary member 120. That is, the diaphragm functions as a valve element of a diaphragm valve. For example, when first protrusion 111 and second protrusion 121 do not press first diaphragm 234, first introduction channel 231 and common channel 260 are communicated with each other through a gap of first diaphragm 234 and first partition wall 233. On the other hand, when first protrusion 111 or second protrusion 121 presses first diaphragm 234 in such a manner that first diaphragm 234 makes contact with first partition wall 233, first introduction channel 231 and common channel 260 are not communicated with each other.

Common channel 260 is a channel in which fluid can move. Common channel 260 is connected to first introduction channel 231 through first valve 232, and connected to second introduction channel 241 through second valve 242. Further, common channel 260 is connected to third introduction channel 251 through third valve 252. Accordingly, fluid introduced to first inlet 230, fluid introduced to second inlet 240, and fluid introduced to third inlet 250 flow through common channel 260. The downstream end of common channel 260 is connected to outlet 270. In the present embodiment, common channel 260 is composed of the groove formed in substrate 210, and film 220 closing the opening of the groove. The cross-sectional area and the cross-sectional shape of common channel 260 are not limited. The cross-sectional shape of common channel 260 is a substantially rectangular shape with each side (width and depth) having a length of about several tens of micrometers, for example. The cross-sectional area of common channel 260 may be or may not be constant in the flow direction of the fluid. In the present embodiment, the cross-sectional area of common channel 260 is constant.

Outlet 270 is a bottomed recess. Outlet 270 functions as an air hole, and as an ejection port for ejecting the fluid in common channel 260. In the present embodiment, outlet 270 is composed of a through hole formed in substrate 210 and film 220 closing one opening of the through hole. The shape and the size of outlet 270 are not limited, and may be appropriately set as necessary. The shape of outlet 270 is a substantially columnar shape, for example. The width of outlet 270 is about 2 mm, for example.

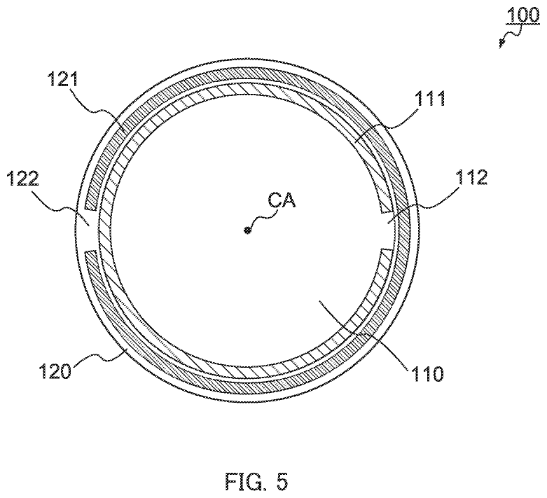

FIG. 5 is a plan view of first rotary member 110 and second rotary member 120 of fluid handling device 100 according to the embodiment. In FIG. 5, for the sake of clarity, hatching is provided on the top surface of first protrusion 111 of first rotary member 110 and the top surface of second protrusion 121 of second rotary member 120.

As described above, fluid handling device 100 includes first rotary member 110 and second rotary member 120 disposed to surround first rotary member 110. First rotary member 110 includes first protrusion 111 configured to press a diaphragm of a valve (first valve 232, second valve 242 or third valve 252) to close to the valve, and first rotary member 110 is rotatable around the rotation axis (central axis CA). First rotary member 110 has a substantially columnar shape. Second rotary member 120, which is disposed to surround first rotary member 110, includes second protrusion 121 configured to press a diaphragm of a valve (first valve 232, second valve 242 or third valve 252) to close the valve. Second rotary member 120 is rotatable around the rotation axis (central axis CA) separately from first rotary member 110.

First protrusion 111 and first recess 112 of first rotary member 110 are disposed on a circumference of a first circle around central axis CA. In the present embodiment, in plan view, first protrusion 111 has an arc shape corresponding to a part of the first circle around central axis CA. The region where first protrusion 111 is not provided on the circumference of the first circle is first recess 112.

Note that it suffices that first protrusion 111 is protruded relative to first recess 112, and that first recess 112 is recessed relative to first protrusion 111. That is, it suffices that first protrusion 111 functions as a pressing part, and that first recess 112 functions as a non-pressing part.

In addition, second protrusion 121 and second recess 122 of second rotary member 120 are disposed on a circumference of a second circle around central axis CA. In the present embodiment, in plan view, second protrusion 121 has an arc shape corresponding to a part of the second circle around central axis CA. The region where second protrusion 121 is not provided on the circumference of the second circle is second recess 122.

Note that it suffices that second protrusion 121 is protruded relative to second recess 122, and that second recess 122 is recessed relative to second protrusion 121. That is, it suffices that second protrusion 121 functions as a pressing part, and that second recess 122 functions as a non-pressing part.

Since first protrusion 111 of first rotary member 110 and second protrusion 121 of second rotary member 120 press a diaphragm of the same valve (first valve 232, second valve 242 or third valve 252), it is preferable that the distance between first protrusion 111 and second protrusion 121 is small. In the present embodiment, the distance between first protrusion 111 and second protrusion 121 is 5 to 150 μm.

In the present embodiment, recess 140 for housing the plurality of rolling members 130 is formed in outer surface (the surface on second rotary member 120 side) 113 of first rotary member 110 and inner surface (the surface on first rotary member 110 side) 123 of second rotary member 120. The cross-sectional shape of recess 140 in the direction along central axis CA is not limited as long as the plurality of rolling members 130 can be appropriately housed. In the present embodiment, recess 140 has a substantially square cross-sectional shape (see FIG. 3). In addition, the size of recess 140 is not limited as long as the plurality of rolling members 130 can appropriately make contact with both first rotary member 110 and second rotary member 120.

The plurality of rolling members 130 is disposed between first rotary member 110 and second rotary member 120, and serves a function of reducing friction between first rotary member 110 and second rotary member 120. The plurality of rolling members 130 is directly disposed between first rotary member 110 and second rotary member 120 without being housed to members (e.g., a track ring) other than first rotary member 110 and second rotary member 120. That is, the plurality of rolling members 130 is in direct contact with first rotary member 110 and second rotary member 120. In the present embodiment, the plurality of rolling members 130 is housed in the above-described recess 140. Note that as long as the plurality of rolling members 130 is disposed in direct contact with first rotary member 110 and second rotary member 120, the plurality of rolling members 130 may be held by a holder for maintaining a constant distance between the plurality of rolling members 130. The plurality of rolling members 130 has the same size, and is slightly larger than recess 140. As a result, when the plurality of rolling members 130 is disposed in recess 140, first rotary member 110 and second rotary member 120 are slightly separated from each other. In the present embodiment, the distance between first rotary member 110 and second rotary member 120 is 5 to 150 μm.

The shape of rolling member 130 is not limited as long as friction between first rotary member 110 and second rotary member 120 can be reduced. Rolling member 130 is a ball or a roller, for example. Examples of the roller include a cylinder roller, a cone roller, and a needle-shaped roller. In addition, the material of rolling member 130 is not limited as long as it provides a required strength, wear resistance, corrosion resistance and the like. Examples of the material of rolling member 130 include ceramics, stainless steel, soda glass, brass, tungsten, high carbon chromium bearing steel, and resin. In the present embodiment, rolling member 130 is a bearing ball made of high carbon chromium bearing steel.

### Operation of Fluid Handling Device

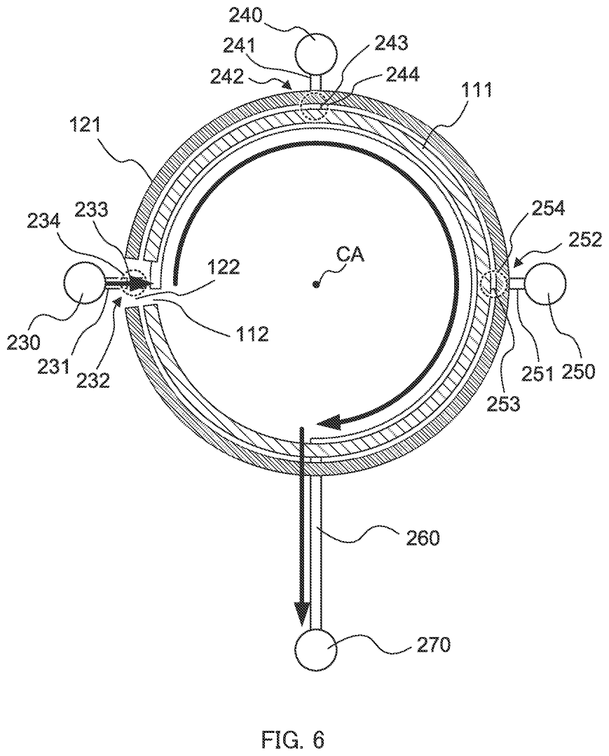

Next, with reference to FIGS. 6 to 8, an operation of fluid handling device 100 is described. For convenience of description, in FIGS. 6 to 8, first protrusion 111 and second protrusion 121 are illustrated with hatching when they are in contact with film 220 of channel chip 200, but are omitted when they are not in contact with film 220 of channel chip 200. Assume that first liquid is housed in first inlet 230, second liquid is housed in second inlet 240, third liquid is housed in third inlet 250, and a pressure is exerted on first inlet 230, second inlet 240 and third inlet 250.

First, first rotary member 110 is rotated such that first recess 112 is located on first valve 232, and first protrusion 111 is located on second valve 242 and third valve 252, and second rotary member 120 is rotated such that second recess 122 is located on first valve 232 and second protrusion 121 is located on second valve 242 and third valve 252, to open first valve 232 and close second valve 242 and third valve 252. In this manner, as illustrated in FIG. 6, the first liquid in first inlet 230 moves to outlet 270 through first introduction channel 231, first valve 232 and common channel 260. At this time, second valve 242 and third valve 252 are closed, and therefore the second liquid in second inlet 240 and the third liquid in third inlet 250 do not flow into common channel 260.

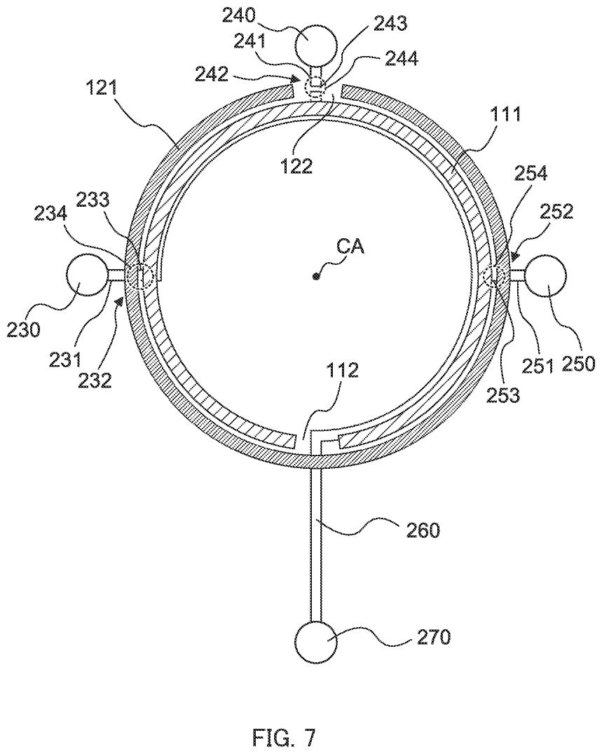

Next, assume that the third liquid in third inlet 250 is to be caused to flow through common channel 260. In this case, it is necessary to rotate first rotary member 110 until first recess 112 is located on third valve 252, and rotate second rotary member 120 until second recess 122 is located on third valve 252. At this time, through rotation of first rotary member 110 and second rotary member 120 in opposite directions and the like, it is ensured that the positions of first recess 112 and second recess 122 do not coincide with each other until third valve 252 is reached. For example, as illustrated in FIG. 7, even when second recess 122 is located on second valve 242 while second rotary member 120 is being rotated, the diaphragm of second valve 242 is pressed by first protrusion 111 of first rotary member 110. Therefore, even when first recess 112 or second recess 122 passes over second valve 242 while first rotary member 110 or second rotary member 120 is being rotated, the second liquid in second inlet 240 does not flow into common channel 260.

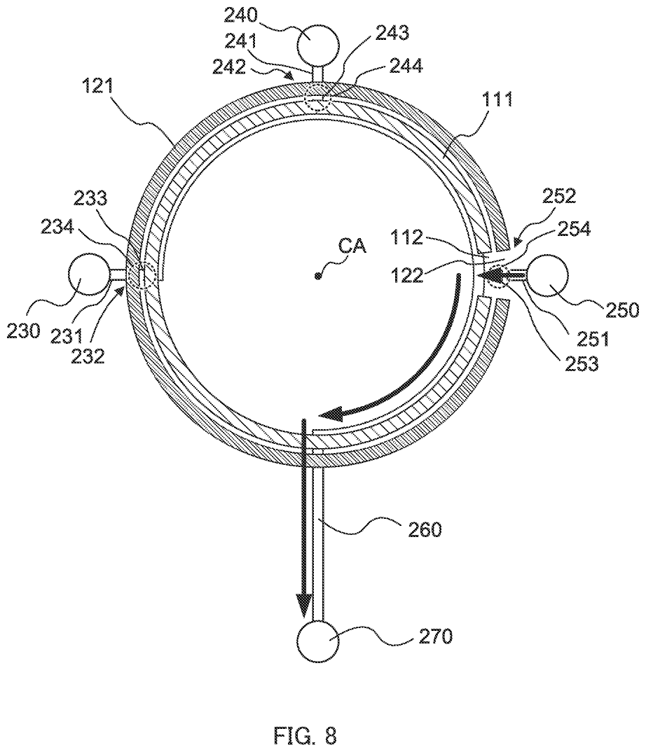

Then, when first recess 112 is located on third valve 252 and first protrusion 111 is located on first valve 232 and second valve 242, the rotation of first rotary member 110 is stopped. In addition, when second recess 122 is located on third valve 252 and second protrusion 121 is located on first valve 232 and second valve 242, the rotation of second rotary member 120 is stopped. In this manner, only third valve 252 is opened. In this manner, as illustrated in FIG. 8, the third liquid in third inlet 250 moves to outlet 270 through third introduction channel 251, third valve 252 and common channel 260. At this time, first valve 232 and second valve 242 are closed, and therefore the first liquid in first inlet 230 and the second liquid in second inlet 240 do not flow into common channel 260.

Through the above-mentioned procedure, the opening and closing of a plurality of valves can be controlled by rotating first rotary member 110 or second rotary member 120 without opening an unintended valve while first rotary member 110 or second rotary member 120 is being rotated.

### Effect

As described above, in fluid handling device 100 according to the present embodiment, the plurality of rolling members 130 is not housed in a member (e.g., a track ring) other than first rotary member 110 and second rotary member 120, but are directly disposed in recess 140 formed between first rotary member 110 and second rotary member 120. For example, in the case where recess 140 is formed in outer surface 113 of first rotary member 110 or the inner surface of second rotary member 120 and a commercially available ball bearing having a track ring is fit in recess 140, a sum of a dimensional error of recess 140 and a dimensional error of the track ring of the ball bearing may affect the distance between first rotary member 110 and second rotary member 120 (i.e., the distance between first protrusion 111 and second protrusion 121). However, with the configuration in which the plurality of rolling members 130 is directly disposed in recess 140 as in the present embodiment, only the dimensional error of recess 140 affects the distance between first rotary member 110 and second rotary member 120 (i.e., the distance between first protrusion 111 and second protrusion 121). Thus, in fluid handling device 100 according to the present embodiment, the friction between first rotary member 110 and second rotary member 120 is small, and the variation of the distance between first rotary member 110 and second rotary member 120 (i.e., the distance between first protrusion 111 and second protrusion 121) is also small. As a result, fluid handling device 100 according to the present embodiment can accurately control the opening and closing of the valve even with the plurality of rotary members.

### Modification

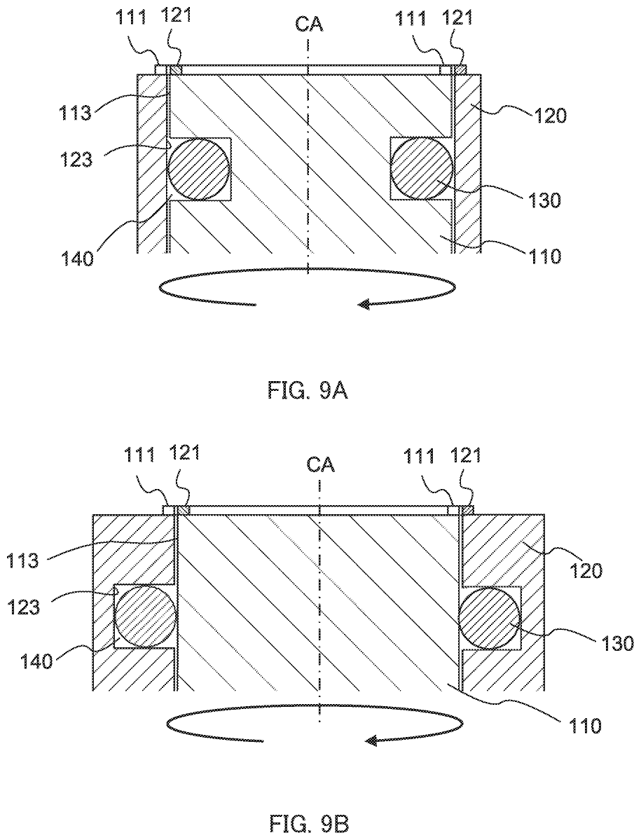

Note that while in the present embodiment, fluid handling device 100 in which recess 140 is formed in outer surface 113 of first rotary member 110 and the inner surface of second rotary member 120 is described above, the present invention is not limited to this. For example, as illustrated in FIG. 9A, recess 140 for housing rolling member 130 may be formed only in outer surface 113 of first rotary member 110, or recess 140 for housing rolling member 130 may be formed only in inner surface 123 of second rotary member 120 as illustrated in FIG. 9B.

This application is entitled to and claims the benefit of Japanese Patent Application No. 2018-132249 filed on Jul. 12, 2018, the disclosure each of which including the specification, drawings and abstract is incorporated herein by reference in its entirety.

### INDUSTRIAL APPLICABILITY

The fluid handling device of the embodiment of the present invention is suitable for various uses such as laboratory tests, food tests, and environment tests, for example.

### REFERENCE SIGNS LIST

10 First inlet
11 First introduction channel
12 First valve
20 Second inlet
21 Second introduction channel
22 Second valve
30 Third inlet
31 Third introduction channel
32 Third valve
40 Common channel
41 Outlet
50 Protrusion of rotary member
51 Recess of rotary member
100 Fluid handling device
110 First rotary member
111 First protrusion
112 First recess
113 Outer surface of first rotary member
120 Second rotary member
121 Second protrusion
122 Second recess
123 Inner surface of second rotary member
130 Rolling member
140 Recess
200 Channel chip
210 Substrate
220 Film
230 First inlet
231 First introduction channel
232 First valve
233 First partition wall
234 First diaphragm
240 Second inlet
241 Second introduction channel
242 Second valve
243 Second partition wall
244 Second diaphragm
250 Third inlet
251 Third introduction channel
252 Third valve
253 Third partition wall
254 Third diaphragm
260 Common channel
270 Outlet
CA Central axis

1. A fluid handling device configured to control fluid in a channel chip including a first channel, a second channel, and a valve disposed between the first channel and the second channel, the fluid handling device comprising:
a first rotary member including a first protrusion and configured to be rotatable around a rotation axis, the first protrusion being configured to press a diaphragm of the valve to close the valve;
a second rotary member disposed to surround the first rotary member and including a second protrusion configured to press the diaphragm of the valve to close the valve, the second rotary member being rotatable around the rotation axis separately from the first rotary member; and
a plurality of rolling members disposed between the first rotary member and the second rotary member, the plurality of rolling members being in contact with the first rotary member and the second rotary member.

2. The fluid handling device according to claim 1, wherein a recess configured to house the plurality of rolling members is formed in a surface of the first rotary member on a second rotary member side or a surface of the second rotary member on a first rotary member side.

3. The fluid handling device according to claim 1, wherein the rolling member is a bearing ball.

4. The fluid handling device according to claim 1, wherein a distance between the first protrusion and the second protrusion is 5 to 150 μm.

5. A fluid handling system comprising:
a channel chip including a first channel, a second channel, and a valve disposed between the first channel and the second channel; and
the fluid handling device according to claim 1.
